(19) United States
(12) Patent Application Publication
(10) Pub. No.: US 2025/0165407 A1
(43) Pub. Date: May 22, 2025

(54) MANAGING DATA SECURITY IN STORAGE DEVICES

(71) Applicant: Macronix International Co., Ltd., Hsinchu (TW)

(72) Inventors: Yu-Ming Huang, Zhubei (TW); Chih-Huai Shih, Taichung (TW); Yung-Chun Li, New Taipei (TW)

(73) Assignee: Macronix International Co., Ltd., Hsinchu (TW)

(21) Appl. No.: 18/517,270

(22) Filed: Nov. 22, 2023

(51) Int. Cl. G06F 12/14; H04L 9/00; H04L 9/08

(52) U.S. Cl. CPC G06F 12/1408; H04L 9/008; H04L 9/0852; G06F 2212/1052

(57) ABSTRACT

Systems, devices, methods, and circuits for managing data security in storage devices. In one aspect, a storage device includes at least one memory device and a controller coupled to the at least one memory device. The controller is configured to: encrypt first data with a first type of cryptographic algorithm and encrypt second data with a second type of cryptographic algorithm. The first data is associated with a first security level, and the second data is associated with a second security level that is higher than the first security level. The second type of cryptographic algorithm has a greater encryption strength than the first type of cryptographic algorithm.

### TECHNICAL FIELD

The present disclosure is directed to data security, e.g., in storage devices.

### BACKGROUND

Protecting data in storage devices from unintentional overwrites, malicious attacks and cloning is essential. To meet security requirements, the data stored in the storage devices can be encrypted.

### SUMMARY

The present disclosure describes methods, devices, systems and techniques for managing data security in storage devices, e.g., solid-state drives (SSDs).

One aspect of the present disclosure features a storage device including: at least one memory device and a controller coupled to the at least one memory device and configured to: encrypt first data with a first type of cryptographic algorithm and encrypt second data with a second type of cryptographic algorithm. The first data is associated with a first security level, and the second data is associated with a second security level that is higher than the first security level, and the second type of cryptographic algorithm has a greater encryption strength than the first type of cryptographic algorithm.

In some implementations, a first ratio between the encrypted first data and the first data is smaller than a second ratio between the encrypted second data and the second data. In some implementations, the second ratio is more than one order of magnitude greater than the first ratio.

In some implementations, the first type of cryptographic algorithm includes an Advanced Encryption Standard (AES) algorithm, and the second type of cryptographic algorithm includes a post-quantum cryptography (PQC) algorithm. In some implementations, the second type of cryptographic algorithm includes a post-quantum cryptography (PQC) algorithm with fully homomorphic encryption (FHE). In some implementations, the second type of cryptographic algorithm includes a lattice-based PQC algorithm.

In some implementations, the controller is configured to encrypt third data with the first type of cryptographic algorithm, and the third data is associated with a third security level that is smaller than the first security level, and the controller is configured to encrypt the first data with a first key and encrypt the third data with a second key, and a size of the second key is smaller than a size of the first key.

In some implementations, the controller is configured to store at least one of the encrypted first data or the encrypted second data in the at least one memory device.

In some implementations, a size of the first data is greater than a size of the second data. The size of the first data can be more than one order of magnitude greater than the size of the second data.

In some implementations, the controller is configured to control an operation for the encrypted second data in the at least one memory device.

In some implementations, the operation for the encrypted second data includes at least one of: a computation between a first portion of the encrypted second data and a second portion of the encrypted second data, or a computation between the encrypted second data and another data encrypted using the second type of cryptographic algorithm.

In some implementations, the controller is configured to transmit at least one of the encrypted first data or the encrypted second data to an external device.

In some implementations, the controller includes: a first encryption engine configured to encrypt the first data using the first type of cryptographic algorithm, and a second encryption engine configured to encrypt the second data using the second type of cryptographic algorithm.

In some implementations, the controller is configured to determine which security level data is associated with and encrypt the data based on the determined security level associated with the data.

In some implementations, the controller is configured to: encrypt the first data using the first type of cryptographic algorithm in response to determining that the first data is associated with the first security level, and encrypt the second data using the second type of cryptographic algorithm in response to determining that the second data is associated with the second security level.

In some implementations, the controller is configured to: determine which security level the data is associated with based on a security label for the data, the security label for the data corresponding to the security level associated with the data.

In some implementations, the controller is configured to determine the security label for the data by receiving the security label for the data from a host device.

In some implementations, the host device includes a security labelling module configured to determine the security label associated with the data.

In some implementations, the controller is configured to determine the security label for the data based on one or more characteristics of the data.

In some implementations, the one or more characteristics of the data include at least one of a source of the data or an importance level of the data.

In some implementations, the controller includes an Error Correction Code (ECC) circuit including at least one of: one or more min-sum (MS) low-density parity-check (LDPC) decoders or one or more bit-flipping-based lite LDPC decoders.

In some implementations, the at least one memory device includes one or more NAND flash memory chips, and the storage device includes a solid-state drive (SSD).

Another aspect of the present disclosure features a storage device including: at least one memory device and a controller coupled to the at least one memory device and configured to: determine, among a plurality of security levels, which security level data is associated with and encrypt the data with a corresponding cryptographic algorithm of a plurality of cryptographic algorithms based on the security level associated with the data. The plurality of cryptographic algorithms include at least two different types of cryptographic algorithms that have different cryptographic strengths. Each of the plurality of security level is associated with a respective one of the plurality of cryptographic algorithms, a higher security level corresponding to a cryptographic algorithm with a higher cryptographic strength.

In some implementations, the controller is configured to perform at least one of: storing the encrypted data in the at least one memory device, transmitting the encrypted data to a host device, conducting computation on the encrypted data to generate an encrypted result, or transmitting the encrypted result to the host device.

In some implementations, the controller is configured to determine which security level the data is associated with based on a security label for the data, the security label for the data corresponding to the security level associated with the data. The controller is configured to determine the security label for the data based on at least one of: receiving the security label for the data from a host device, or determining the security label for the data based on one or more characteristics of the data.

Another aspect of the present disclosure features a method of managing data security in a storage device. The method includes: determining, among a plurality of security levels, which security level data in the storage device is associated with, and encrypting the data with a corresponding cryptographic algorithm of a plurality of cryptographic algorithms based on the security level associated with the data. The plurality of cryptographic algorithms includes at least two different types of cryptographic algorithms that have different cryptographic strengths, and each of the plurality of security level is associated with a respective one of the plurality of cryptographic algorithms, a higher security level corresponding to a cryptographic algorithm with a higher cryptographic strength.

Another aspect of the present disclosure features a method of managing data security in a storage device. The method includes: encrypt first data with a first type of cryptographic algorithm in the storage device and encrypt second data with a second type of cryptographic algorithm in the storage device. The first data is associated with a first security level, and the second data is associated with a second security level that is higher than the first security level, and the second type of cryptographic algorithm has a greater encryption strength than the first type of cryptographic algorithm.

Implementations of the above techniques include methods, systems, circuits, computer program products and computer-readable media. In one example, a method can include the above-described actions. In another example, one such computer program product is suitably embodied in a non-transitory machine-readable medium that stores instructions executable by one or more processors. The instructions are configured to cause the one or more processors to perform the above-described actions. One such computer-readable medium stores instructions that, when executed by one or more processors, are configured to cause the one or more processors to perform the above-described actions.

The details of one or more disclosed implementations are set forth in the accompanying drawings and the description below. Other features, aspects, and advantages will become apparent from the description, the drawings and the claims.

### BRIEF DESCRIPTION OF THE DRAWINGS

FIG. 1 illustrates an example system including a storage device with one or more encryption engines.

FIG. 2 illustrates another example system including a storage device with one encryption engine.

FIG. 3 illustrates another example system including a storage device with at least two encryption engines.

FIG. 4 illustrates an example flow chart of a process of symmetric key cryptography.

FIG. 5 illustrates an example flow chart of a process of asymmetric key cryptography.

FIG. 6 illustrates an example flow chart of a process of fully homomorphic encryption (FHE) cryptography.

FIG. 7 illustrates example cryptographic algorithms for encryption of data associated with different security levels.

FIG. 8 is a flow chart of an example process for managing data security in a storage device.

Like reference numbers and designations in the various drawings indicate like elements. It is also to be understood that the various exemplary implementations shown in the figures are merely illustrative representations and are not necessarily drawn to scale.

### DETAILED DESCRIPTION

Data cryptography can include three data states: data in motion, data at rest, and data in use. In some implementations, symmetric key cryptography is used to protect data at rest, e.g., using a same encryption key to both encrypt and decrypt data. In some examples, a self-encrypting drive (SED) can be a hard disk drive (HDD) or solid-state drive (SSD) designed to automatically encrypt and decrypt drive data without the need for user input or disk encryption software. In some implementations, asymmetric key cryptography is used to secure data in motion, e.g., using a pair of keys (public key and private key) for data encryption and decryption. Public key can be used to encrypt data and can be freely given, while private key is used to decrypt the encrypted data (e.g., cypher text) and is safeguarded as it is the only key that can decrypt the encrypted data.

Quantum computing may enable to decrypt encrypted data, e.g., using one or more quantum algorithms such as Shor's algorithm (e.g., for asymmetric key cryptography) or Grover's algorithm (e.g., for symmetric key cryptography). The threat of Grover's algorithm can be addressed, e.g., by increasing (such as doubling or tripling) a key length. Quantum-safe encryption technology can be used to address the threat of quantum computing for data cryptography. For example, post-quantum cryptography (PQC) can be configured to address the threat of Shor's algorithm to asymmetric key cryptography. PQC algorithm can include code-based cryptography, lattice-based cryptography, multivariate cryptography, hash-based cryptography, or supersingular elliptic curve isogeny cryptography.

In some implementations, homomorphic encryption (HE) is used to secure data in use. Homomorphic encryption is a form of encryption that allows computations to be performed on encrypted data without first having to decrypt it. The resulting computations are left in an encrypted form which, when decrypted, result in an output that is identical to that produced had the operations been performed on the unencrypted data. Homomorphic encryption can be used for privacy-preserving outsourced storage and computation. This allows data to be encrypted and out-sourced (e.g., to commercial cloud environments for processing), all while encrypted. Homomorphic encryption can eliminate the need for processing data in the clear, thereby preventing attacks that would enable a hacker to access that data while it is being processed. For sensitive data, such as health care information, homomorphic encryption can be used to enable new services, e.g., by removing privacy barriers inhibiting data sharing or increasing security to existing services.

Homomorphic encryption can include multiple types of encryption schemes that can perform different classes of computations over encrypted data. The computations can be represented as either Boolean or arithmetic circuits. Homomorphic encryption can include partially homomorphic, somewhat homomorphic, leveled fully homomorphic, or fully homomorphic encryption (FHE). For example, FHE is a cryptosystem that supports arbitrary computation on ciphertexts and enables the construction of programs for any desirable functionality, which can be run on encrypted inputs to produce an encryption of the result. Since FHE does not need decryption of its inputs, FHE can be run by an untrusted party without revealing its inputs and internal state. In some implementations, PQC is configured to implement FHE. For example, lattice-based cryptography can not only be quantum-safe but also implement a fully homomorphic encryption, which can be used to secure data in use.

Implementations of the present disclosure provide techniques for managing data security in storage devices such as solid-state drives (SSDs). Different from storage devices with one level or type of cryptography for all data, the techniques enable to perform different levels of cryptography on different security levels of data, e.g., by labelling data with corresponding security levels. The security levels of data can include non-confidential level, confidential level, highly confidential level, and top secret level. The levels of cryptography can include different types of cryptographic algorithms, e.g., Advanced Encryption Standard (AES) algorithm, post-quantum cryptography (PQC) algorithm such as PQC with fully homomorphic encryption (FHE) (e.g., lattice-based PQC). AES can have a key size (or key length) of 128, 192, or 256 bits, where larger sizes indicate greater encryption strengths. In some examples, non-confidential data can be stored as plain text without encryption; confidential data can be encrypted using AES algorithm (e.g., AES with a lower strength like AES-128); highly confidential data can be encrypted using enhanced AES algorithm (e.g., AES with a higher strength like AES-192 or AES-256); and top secret data can be encrypted using PQC algorithm with FHE (PQC-FHE). In such a way, the top secret data can be protected by the PQC algorithm against quantum attack. Also, as the cost of using the PQC algorithm for encryption is much higher than normal encryption (e.g., AES), the techniques enable to only select data with the top secret level for the PQC encryption, which can provide protection for the top secret data without significantly increasing overheads (e.g., costs, computational and storage resources) of the storage device.

In some implementations, the storage device includes at least two types of encryption engines configured to encrypt data using different types of cryptographic algorithms, e.g., AES and PQC. In some implementations, the storage device includes an Error Correction Code (ECC) circuitry that can include one or more encoders/decoders such as low-density parity-check (LDPC) encoders/decoders. The LDPC decoders can include min-sum (MS) LDPC decoders or low-cost bit-flipping-based lite LDPC decoders. To compensate hardware overhead in the encryption part (e.g., a PQC encryption engine), the ECC circuitry can include a smaller number of MS LDPC decoders compared to a storage device including only one encryption engine (e.g., AES encryption engine) or include one or more low-cost bit-flipping-based lite LDPC decoders in replace of one or more MS LDPC decoders.

In some implementations, security labels are determined by a host device (e.g., from a user) directly or can follow a specific rule. For example, data from specific computers and/or users or specific data can be labeled with top secret level to be encrypted with a cryptographic algorithm with a highest encryption strength (e.g., PQC-FHE). A component for implementing security labels can be included in the host device, in a storage device, or in both the host device and the storage device.

The techniques implemented herein can be applied to various types of storage devices, such as volatile memory devices, or non-volatile memory (NVM) devices, such as NAND flash memory, NOR flash memory, resistive random-access memory (RRAM), phase-change memory (PCM) such as phase-change random-access memory (PCRAM), spin-transfer torque (STT)-Magnetoresistive random-access memory (MRAM), among others. The techniques can also be applied to charge-trapping based memory devices, e.g., silicon-oxide-nitride-oxide-silicon (SONOS) memory devices, and floating-gate based memory devices. The techniques can be applied to two-dimensional (2D) memory devices or three-dimensional (3D) memory devices. The techniques can be applied to various memory types, such as SLC (single-level cell) devices, MLC (multi-level cell) devices like 2-level cell devices, TLC (triple-level cell) devices, QLC (quad-level cell) devices, or PLC (penta-level cell) devices. Additionally or alternatively, the techniques can be applied to various types of devices and systems, such as secure digital (SD) cards, embedded multimedia cards (eMMC), solid-state drives (SSDs) (consumer SSDs and/or enterprise SSDs), hard disk drives (HDDs), cloud computing or cloud distributed storage devices or systems, embedded systems, among others. These devices and systems can be applied for protecting sensitive government data, financial data, and/or military data.

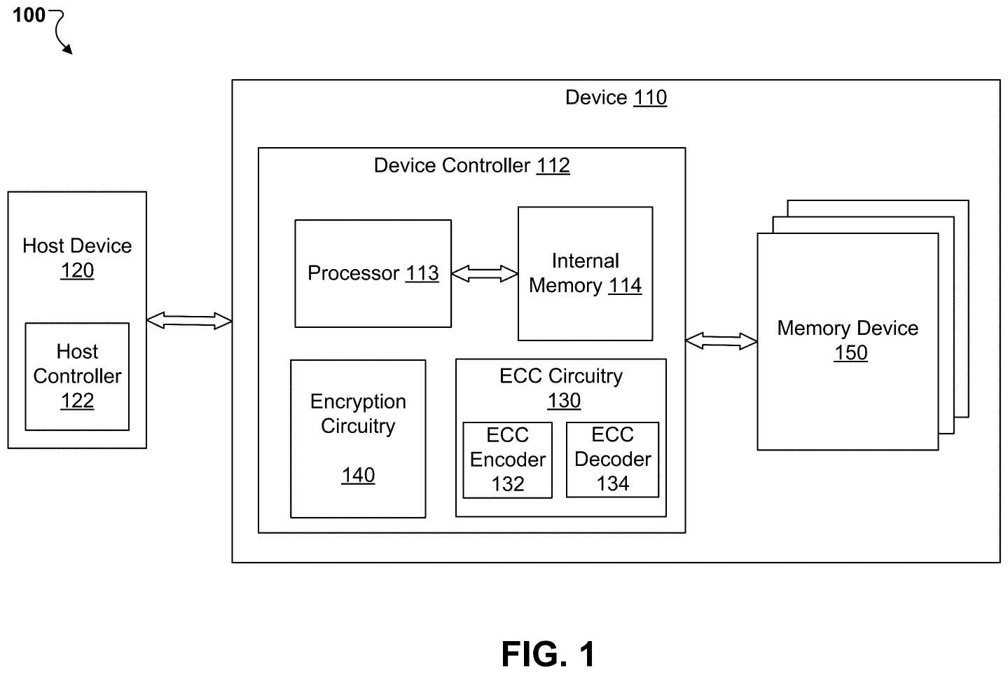

FIG. 1 illustrates an example system 100 including a storage device with one or more encryption engines. The system 100 includes a device 110 and a host device 120. The host device 120 includes a host controller 122 that can include at least one processor and at least one memory coupled to the at least one processor and storing programming instructions for execution by the at least one processor to perform one or more corresponding operations.

In some implementations, the device 110 is a storage device. For example, the device 110 can be an embedded multimedia card (eMMC), a secure digital (SD) card, a solid-state drive (SSD), or some other suitable storage. In some implementations, the device 110 is a smart watch, a digital camera or a media player. In some implementations, the device 110 is a client device that is coupled to a host device 120. For example, the device 110 is an SD card in a digital camera or a media player that is the host device 120.

In some implementations, the host device 120 is coupled to one or more devices 110 (e.g., SSDs). Each device 110 can include a device controller 112 and one or more memory devices 150 each coupled to the device controller 112. A memory device 150 can include a memory chip, e.g., NAND flash memory chip.

The device controller 112 is a general-purpose microprocessor, or an application-specific microcontroller. In some implementations, the device controller 112 is a memory controller for the device 110. The following sections describe the various techniques based on implementations in which the device controller 112 is a memory controller. However, the techniques described in the following sections are also applicable in implementations in which the device controller 112 is another type of controller that is different from a memory controller.

In some implementations, the device controller 112 includes a processor 113 and an internal memory 114. The processor 113 is configured to execute instructions and process data. The instructions include firmware instructions and/or other program instructions that are stored as firmware code and/or other program code, respectively, in the secondary memory. The data includes program data corresponding to the firmware and/or other programs executed by the processor, among other suitable data. In some implementations, the processor 113 is a general-purpose microprocessor, or an application-specific microcontroller. The processor 113 is also referred to as a central processing unit (CPU).

The processor 113 accesses instructions and data from the internal memory 114. In some implementations, the internal memory 114 is a Static Random Access Memory (SRAM) or a Dynamic Random Access Memory (DRAM). For example, in some implementations, when the device 110 is an eMMC, an SD card or a smart watch, the internal memory 114 is an SRAM. In some implementations, when the device 110 is a digital camera or a media player, the internal memory 114 is DRAM.

In some implementations, the internal memory 114 is a cache memory that is included in the device controller 112. The internal memory 114 stores instruction codes, which correspond to the instructions executed by the processor 113, and/or the data that are requested by the processor 113 during runtime.

The device controller 112 transfers the instruction code and/or the data from the one or more memory devices 150 to the internal memory 114. In some implementations, the memory device 150 is a storage device or a non-volatile memory (NVM) that is configured for long-term storage of instructions and/or data, e.g., a NAND flash memory device, or some other suitable non-volatile memory device. In implementations where the memory device 150 is a NAND flash memory chip, the device 110 is a flash memory device, e.g., a flash memory card, and the device controller 112 is a NAND flash controller. For example, in some implementations, when the device 110 is an eMMC or an SD card, the memory device 150 is a NAND flash; in some implementations, when the device 110 is a digital camera, the memory device 150 is an SD card; and in some implementations, when the device 110 is a media player, the memory device 150 is a hard disk.

In some implementations, the device controller 112 is configured to receive data and instructions from and to send data to the host device 120. The device controller 112 is further configured to send data and commands to the memory device 150 and to receive data from the memory device 150. For example, the device controller 112 is configured to send data and a write command to instruct the memory device 150 to store the data to a specified address. As another example, the device controller 112 is configured to receive a read request (or a read command) from the host device 120 and send a corresponding read command to the memory device 150 to read data from a specified address in the memory device 150.

In some implementations, as shown in FIG. 1, the device controller 112 includes an ECC circuitry 130. The ECC circuitry 130 can include an ECC encoder 132 and an ECC decoder 134. In some implementations, the ECC circuitry 130 can be arranged to be externally coupled to the device controller 112.

The ECC encoder 132 can be configured to receive data to be stored in the memory device 150 and to generate check bits, e.g., by encoding the data using an ECC encoding scheme. The check bits can be referred to as ECC data. The ECC encoder 132 can include a Reed Solomon encoder, a Bose-Chaudhuri-Hocquenghem (BCH) encoder, a low-density parity check (LDPC) encoder, or any combination thereof. The ECC decoder 134 can be configured to decode data read from the memory device 150 to detect and correct, up to an error correction capability of the ECC scheme, any bit errors that may be present in the data. The ECC decoder 134 can perform BCH decoding or LDPC decoding. In some examples, the ECC decoder 134 includes one or more min-sum (MS) LDPC decoders. In some examples, the ECC decoder 134 includes one or more bit-flipping-based lite LDPC decoders. A MS LDPC decoder can have a greater decoding capability and a higher decoding speed than the bit-flipping-based lite LDPC decoder, while the lite LDPC decoder can have a lower cost than the MS LDPC decoder.

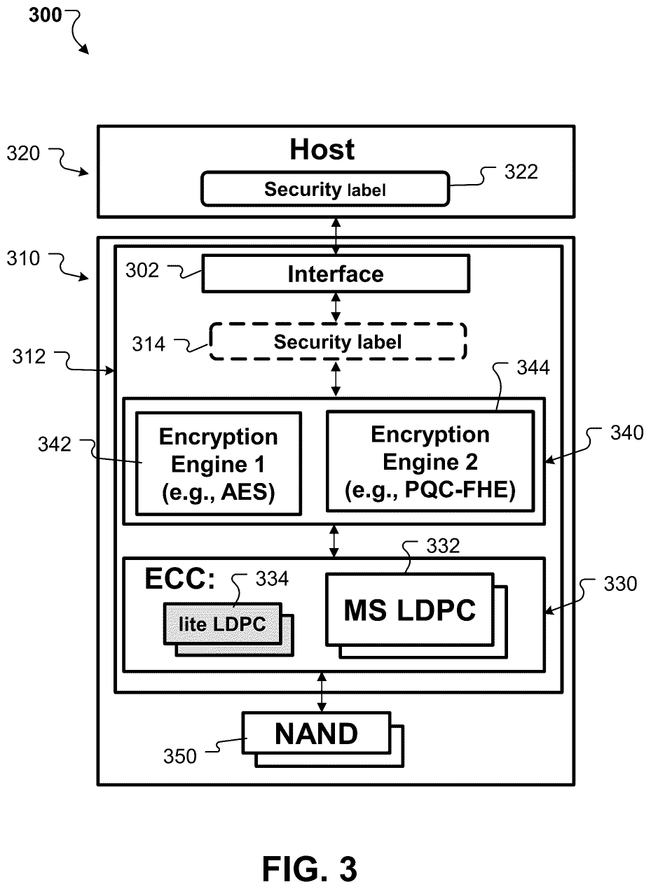

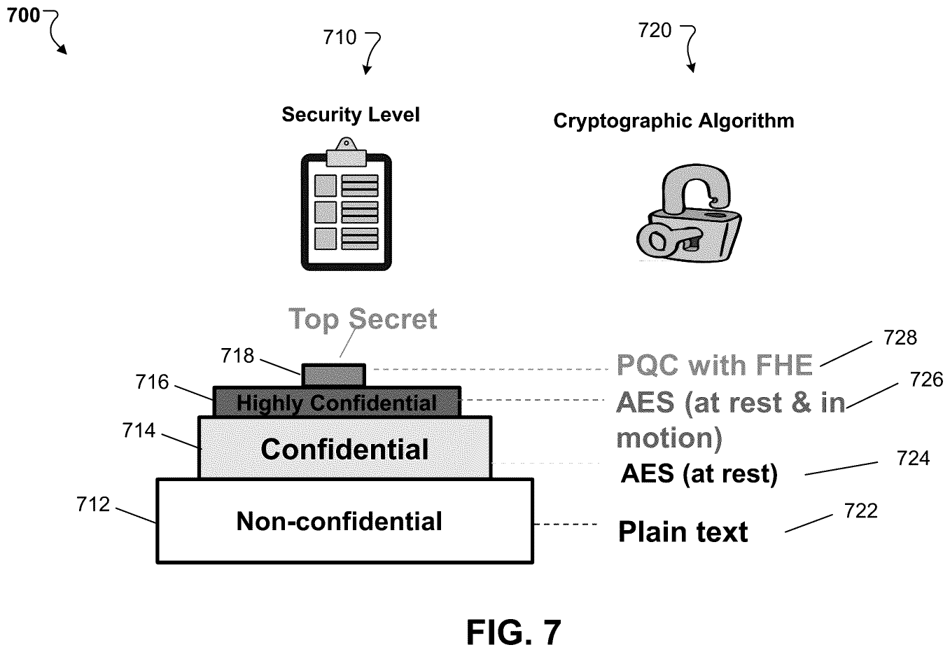

In some implementations, e.g., as illustrated in FIG. 1, the device controller 112 includes an encryption circuitry 140 that can include one or more encryption engines. Each encryption engine is configured to encrypt data using a corresponding type of cryptographic algorithm (or encryption algorithm). The encryption engine can include one or more logic units or circuits or a combination thereof. As described with further details in FIGS. 3 and 7, the device controller 112 can be configured to encrypt data with different security levels using different cryptographic algorithms with different cryptographic strengths (or encryption strengths). In such a way, data with a higher security level can be encrypted or secured with a corresponding cryptographic algorithm with a greater encryption strength. In some implementations, the encryption circuitry 140 is arranged in the device 110 but externally coupled to the device controller 112. The encryption circuitry 140 can encrypt data from the host device 120 and transmit the encrypted data to the device controller 112 or the memory device(s) 150.

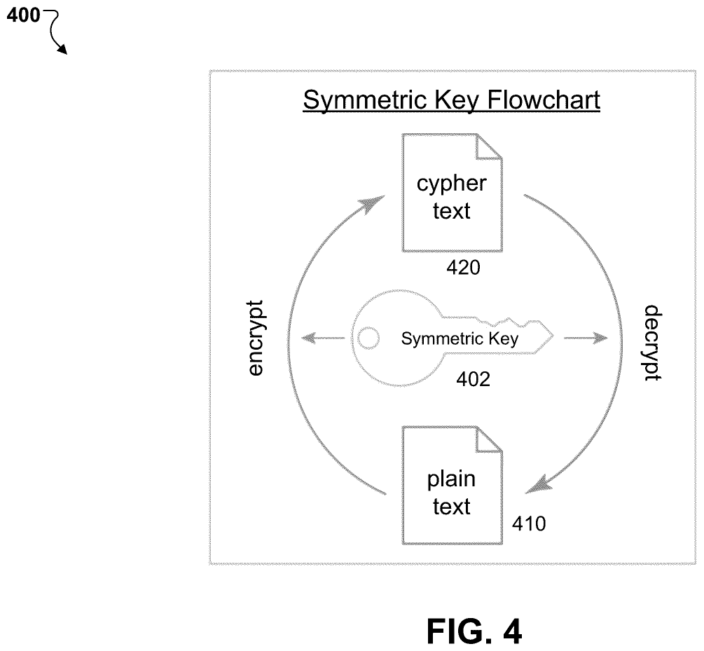

In some implementations, e.g., as described with respect to FIG. 4, an encryption engine is configured to encrypt data using a symmetric-key cryptographic algorithm, e.g., Advanced Encryption Standard (AES) or Triple Data Encryption Standard (3DES or TDES). The symmetric-key cryptographic algorithm can be used to secure data at rest.

In some examples, triple DES uses three 56-bit keys. In some examples, the AES algorithm has a 128-bit key, a 192-bit key, or a 256-bit key, where a larger bit key size indicates a greater encryption strength. AES algorithm can be combined with Galois/Counter Mode (GCM), which is known as AES-GCM with 256-bit secret key. Note that the AES algorithms with secret keys of different bits can be considered as a same type of cryptographic algorithm.

FIG. 4 illustrates an example flow chart 400 of a process of symmetric key cryptography. In the symmetric key cryptography, a same encryption key 402 is used to both encrypt data (e.g., plain text 410) and decrypt data (e.g., cypher text 420). In some examples, both a sender (e.g., the host device 120 of FIG. 1) and a recipient (e.g., the device 110 of FIG. 1) share a single encryption key 402. The sender uses the encryption key 402 to encrypt the plain text 410 to generate the cypher text 420. Then, the cypher text 420 is sent to the recipient, and the recipient can apply the same encryption key 402 to decrypt the cypher text 420 and recover the plain text 410 from the host device. The symmetric key cryptography can be used to protect data at rest.

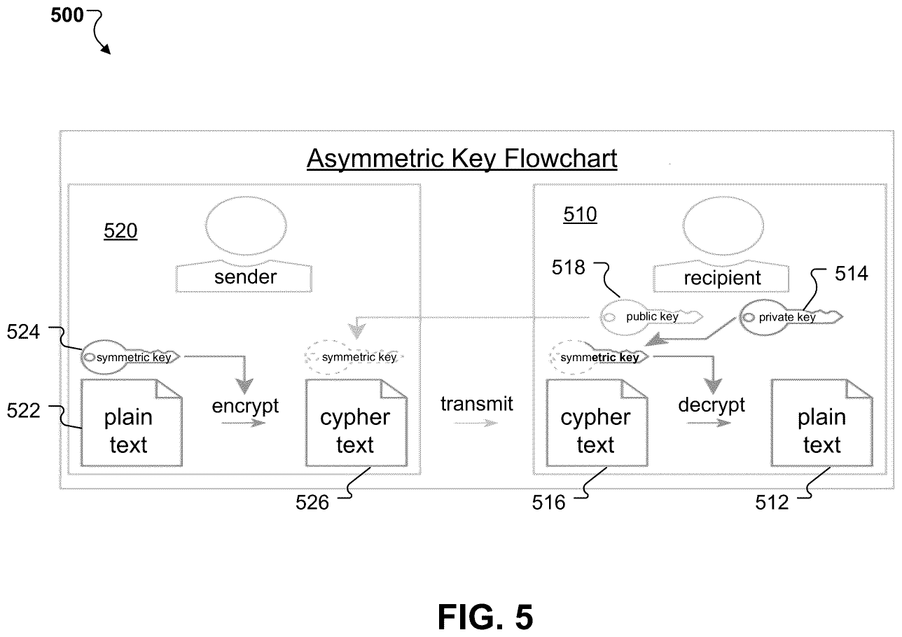

In some implementations, e.g., as described with respect to FIG. 5, an encryption engine is configured to encrypt data using an asymmetric-key (or public-key) cryptographic algorithm. The asymmetric-key cryptographic algorithm can be used to secure data in motion. The asymmetric cryptographic algorithm can include, e.g., Rivest-Shamir-Adleman (RSA) asymmetric algorithm or Elliptic Curve Cryptography (ECC) asymmetric algorithm. The RSA asymmetric algorithm can have a secret key, e.g., with a size of 1024 bits or 2048 bits, to maintain sufficient cryptographic strength. ECC asymmetric algorithm can offer a same level of cryptographic strength at a much smaller key size than the RSA asymmetric algorithm, offering improved security with reduced computational and storage requirements.

In some implementations, an encryption engine is configured to encrypt data using post-quantum cryptography (PQC) algorithm configured to secure the data against a cryptanalytic attack by a quantum computer. The PQC algorithm can be implemented as an asymmetric-key algorithm. The PQC algorithm can include: code-based cryptography, lattice-based cryptography, multivariate cryptography, hash-based cryptography, or supersingular elliptic curve isogeny cryptography.

FIG. 5 illustrates an example flow chart 500 of a process of asymmetric key cryptography between a sender 520 (e.g., the host device 120 of FIG. 1) and a recipient 510 (e.g., the device 110 of FIG. 1). Asymmetric keys are a pair of keys (public key 518 and private key 514) for the encryption and decryption. The public key 518 is used to encrypt data (e.g., plain text 522) and can be freely given. The private key 514 is used to decrypt the encrypted data (e.g., cypher text 526). The private key 514 is safeguarded as it is the only key that can decrypt the encrypted data.

In some examples, the sender 520 uses a symmetric key 524 to encrypt the plain text 522 to obtain cypher text 516. The cypher text 516 and the symmetric key 524 can both be encrypted using the public key 518 to obtain the cypher text 526. The sender 520 can then transmit the cypher text 526 to the recipient 510. The recipient 510 can first use the private key 514 to decrypt the cypher text 526 to obtain the symmetric key 524 and the cypher text 516. Then the recipient 510 can use the decrypted symmetric key 524 to decrypt the cypher text 516 to obtain the plain text 512. In such a way, even the recipient 510 does not store the symmetric key 524, the recipient 510 can obtain the symmetric key 524 by decrypting the cypher text 526 transmitted from the sender 520.

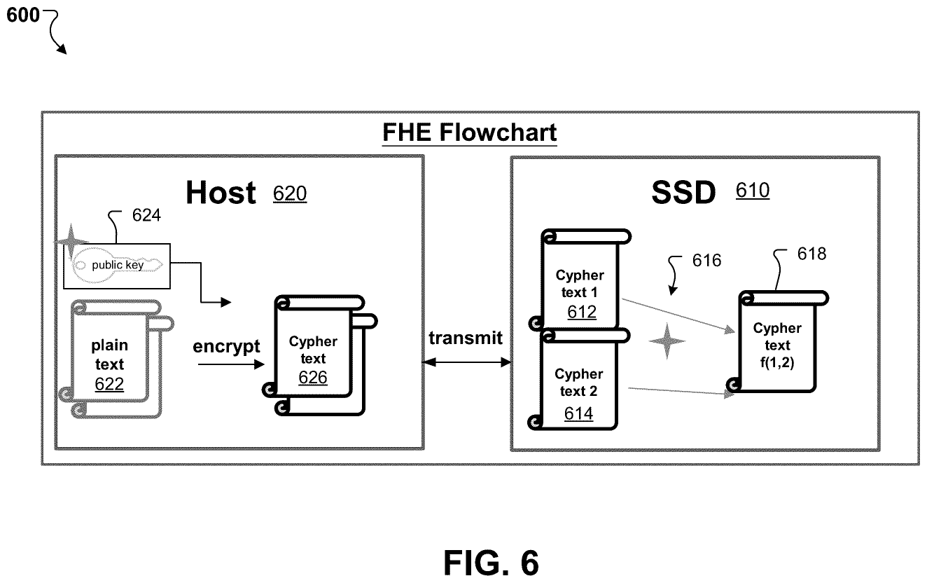

In some implementations, e.g., as described with respect to FIG. 6, an encryption engine is configured to encrypt data using a homomorphic encryption algorithm that allows computations to be performed on encrypted data without first having to decrypt it. The homomorphic encryption cryptographic algorithm can be used to secure data in use. Homomorphic encryption includes multiple types of encryption schemes that can perform different classes of computations over encrypted data. The computations are represented as either Boolean or arithmetic circuits. In some examples, a type of homomorphic encryption includes partially homomorphic, somewhat homomorphic, leveled fully homomorphic, or fully homomorphic encryption (FHE). In some implementations, an encryption engine is configured to encrypt data using PQC algorithm with FHE (or PQC-FHE), e.g., lattice-based PQC algorithm that can be not only quantum-safe but also a fully homomorphic encryption. In some cases, Learning with errors (LWE) can be used in cryptography to create a secure encryption algorithm such as PQC-FHE algorithm.

FIG. 6 illustrates an example flowchart 600 of a process of fully homomorphic encryption (FHE) cryptography between a host device 620 (e.g., the host device 120 of FIG. 1) and a storage device 610 (e.g., the device 110 of FIG. 1). The storage device 610 can be a solid-state drive (SSD).

As illustrated in FIG. 6, the host device 620 can encrypt plain text 622 with a public key 624 using a FHE cryptographic algorithm (e.g., PQC-FHE or lattice-based PQC) to generate cypher text 626. The host device 620 transmits the cypher text 626 to the storage device 610. The storage device 610 can be configured to perform an operation 616 on cypher text 612 and cypher text 614 to obtain a new cypher text 618 that can be a function of the cypher text 612 and the cypher text 614. In some examples, the cypher text 612 and the cypher text 614 can be different portions of the cypher text 626. In some examples, the cypher text 612 is the cypher text 626, and the cypher text 614 is another cypher text encrypted using the same FHE cryptographic algorithm by the host device 620. The storage device 610 and the host device 620 can have a protocol such that the storage device 610 can perform the operation 616 on the cypher text 612 and the cypher text 614, without decrypting the cypher text 612 and the cypher text 614. The storage device 610 can further transmit the cypher text 618 to the host device 620, and the host device 620 can be configured to decrypt the cypher text 618 using the FHE cryptographic algorithm with a private key corresponding to the public key 624. In such way, the FHE cryptographic algorithm can be used to secure data in use.

Each encryption engine is configured to encrypt data using a corresponding type of cryptographic algorithm (or encryption algorithm). A symmetric-key cryptographic algorithm, an asymmetric-key cryptographic algorithm, and a homomorphic encryption algorithm can be considered as different types of cryptographic algorithms. For example, AES and PQC (or PQC with FHE) can be considered as different types of cryptographic algorithms. AES (or 3DES and RSA (or ECC asymmetric algorithm) can be also considered as different types of cryptographic algorithms. RSA (or ECC asymmetric algorithm) and PQC (or PQC with FHE) can be also considered as different types of cryptographic algorithms.

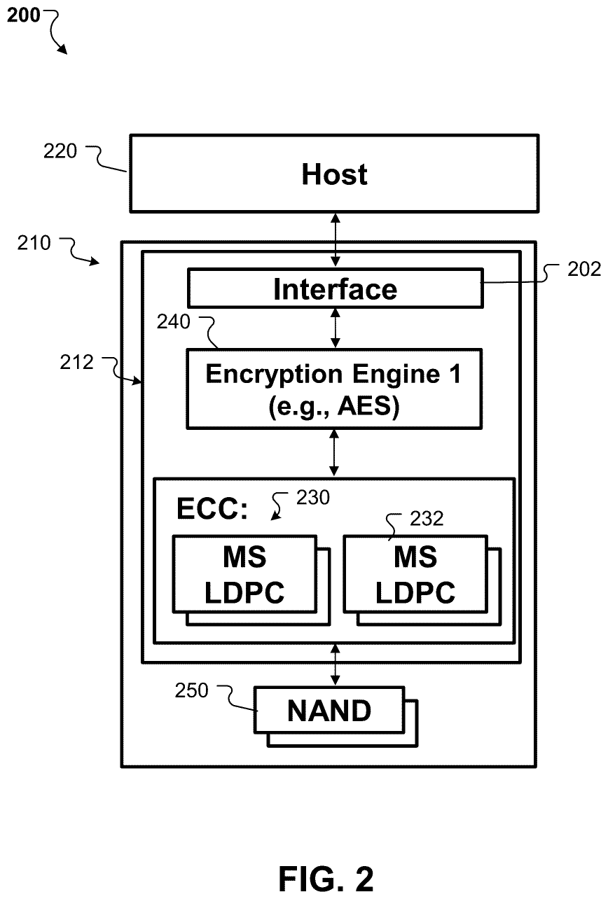

FIG. 2 illustrates another example system 200 including a storage device 210 with one encryption engine. The system 200 can be implemented as the system 100 of FIG. 1. As illustrated in FIG. 2, the system 200 includes a host device 220 (e.g., the host device 120 of FIG. 1) and the storage device 210 (e.g., the storage device 110 of FIG. 1). The storage device 210 can include a controller 212 (e.g., the device controller 112 of FIG. 1) and one or more memory devices 250 (e.g., the memory device 150 of FIG. 1). A memory device 250 can include a NAND memory chip. The storage device 210 can include a solid-state drive (SSD). The storage device 210 is configured to communicate with the host device 220 through an interface 202.

In some implementations, the storage device 210 includes an encryption engine 240 configured to encrypt data (e.g., from the host device 220) using one type of cryptographic algorithm, e.g., a symmetric-key algorithm such as AES, an asymmetric-key algorithm such as RSA or PQC, or a homomorphic encryption algorithm such as FHE. The encryption engine 240 can be implemented as the encryption circuitry 140 of FIG. 1.

In some implementations, the storage device 210 includes an ECC circuit 230 (e.g., the ECC circuitry 130 of FIG. 1). The ECC circuit 230 can include one or more ECC decoders (e.g., the ECC decoder 134 of FIG. 1). In some implementations, the ECC circuit 230 includes multiple MS LDPC decoders 232 to increase a performance of the ECC circuit 230 and the storage device 210.

FIG. 3 illustrates another example system 300 including a storage device 310 with at least two encryption engines. The system 300 can be implemented as the system 100 of FIG. 1. As illustrated in FIG. 3, the system 300 includes a host device 320 (e.g., the host device 120 of FIG. 1 or the host device 220 of FIG. 2) and the storage device 310 (e.g., the storage device 110 of FIG. 1). The storage device 310 can include a controller 312 (e.g., the controller 112 of FIG. 1) and one or more memory devices 350 (e.g., the memory device 150 of FIG. 1 or the memory device 250 of FIG. 1). A memory device 250 can include a NAND memory chip. The storage device 210 can include a solid-state drive (SSD). The storage device 310 is configured to communicate with the host device 320 through an interface 302.

Different from the storage device 210 of FIG. 2 that includes one encryption engine 240, the storage device 310 includes an encryption circuitry 340 having at least two encryption engines 342, 344. The encryption circuitry 340 can be implemented as the encryption circuitry 140 of FIG. 1. The encryption circuitry 340 can be configured to encrypt data with different security levels using different types of cryptographic algorithms by corresponding encryption engines. As noted above, different types of cryptographic algorithms can have different cryptographic (or encryption) strengths. The different types of cryptographic algorithms can include two or more of a symmetric-key algorithm such as AES, an asymmetric-key algorithm such as RSA or PQC, or a homomorphic encryption algorithm such as FHE or PQC-FHE. The encryption engine 342 can be same as, or similar to, the encryption engine 240 of FIG. 2. The encryption engine 344 can be different from the encryption engine 342 and different from the encryption engine 240 of FIG. 2. The encryption engine 344 can be configured to encrypt data with a greater encryption strength than the encryption engine 342.

In some implementations, e.g., as illustrated in FIG. 3, the encryption engine 342 is configured to encrypt data using an AES algorithm, and the encryption engine 344 is configured to encrypt data using a PQC algorithm such as PQC-FHE. The PQC-FHE algorithm can have a greater encryption strength than the AES algorithm and can be used to secure data with a higher security level, e.g., as described with further details in FIG. 7.

In some implementations, as the AES algorithm can use different sizes of secret keys, the encryption engine 342 can be used to encrypt data with different security levels using secret keys with different sizes. For example, an AES algorithm with a 256-bit secret key can be used to encrypt first data, an AES algorithm with a 192-bit secret key can be used to encrypt second data, and an AES algorithm with a 128-bit secret key can be used to encrypt third data. The first data can have a higher security level than the second data, and the second data can have a higher security level than the third data.

In some examples, using the AES algorithm, the encryption engine 342 encrypts data to obtain encrypted data. A first ratio between the encrypted data and the data using the AES algorithm is identical to 1. In some examples, using the PQC-FHE algorithm, the encryption engine 344 encrypts data to obtain encrypted data. A second ratio between the encrypted data and the data using the PQC-FHE algorithm is greater than 1. In some cases, the second ratio can be more than one order of magnitude greater than 1, e.g., 30 to 100 or more, or over 1000. The encryption engine 344 can consume more computational resources, e.g., computation power and/or storage spaces with higher costs, than the encryption engine 342. The encryption engine 344 can also have a slower encryption speed than the encryption engine 342.

The storage device 310 includes an ECC circuitry 330 (e.g., the ECC circuitry 130 of FIG. 1). The ECC circuitry 330 can include one or more ECC decoders (e.g., the ECC decoder 134 of FIG. 1). In some implementations, the ECC circuitry 330 includes one or more MS LDPC decoders 332. The number of the one or more MS LDPC decoders 332 can be smaller than the number of MS LDPC decoders 232 in the ECC circuit 230 of FIG. 2. In some implementations, the ECC circuitry 330 includes one or more bit-flipping-based lite LDPC decoders 334. In some implementations, the ECC circuitry 330 includes at least MS LDPC decoder 332 and at least one lite LDPC decoder 334.

In some implementations, the controller 312 determines, among a plurality of security levels, which security level the data is associated with and encrypt the data with a corresponding cryptographic algorithm of a plurality of cryptographic algorithms based on the security level associated with the data. Each security level can be associated with a respective cryptographic algorithm (e.g., AES-128, AES-192, AES-256, or PQC-FHE). The associations between security levels and the cryptographic algorithms can be stored in the storage device 310 (e.g., in the controller 312). The controller 312 can select a corresponding encryption engine, e.g., the encryption engine 342 or the encryption engine 344, based on the corresponding cryptographic algorithm associated with the determined security level.

FIG. 7 illustrates an example 700 of example cryptographic algorithms for encryption of data associated with different security levels. As illustrated in FIG. 7, a plurality of security levels 710 can include: non-confidential level 712, confidential level 714, highly confidential level 716, and top secret level 718. A plurality of cryptographic algorithms 720 can include: a first AES algorithm 724, a second AES algorithm 726, and PQC-FHE algorithm 728. The second AES algorithm 726 can have a greater encryption strength than the first AES algorithm 724. The first AES algorithm 724 can be configured to protect data at rest, while the second AES algorithm 726 can be configured to protect data in motion and optionally data at rest.

In some examples, e.g., as illustrated in FIG. 4, the first AES algorithm 724, as a symmetric key cryptography, can be used to protect data at rest, e.g., using a same encryption key to both encrypt and decrypt data, for example, in a self-encrypting drive (SED). In some examples, e.g., as illustrated in FIG. 5, the second AES algorithm 726 can be applied for data in motion. The second AES algorithm 726 can be used to encrypt original data (e.g., plain text 522 of FIG. 5) using a symmetric key (e.g., the symmetric key 524 of FIG. 5) in a host device (e.g., the sender 520 of FIG. 5). Then, the encrypted data (e.g., the cypher text 526 of FIG. 5) can be transmitted with the protection of asymmetric encryption to a storage device (e.g., the recipient 510 of FIG. 5). The storage device can be an SSD. In some cases, the storage device can store the encrypted data directly, without decryption. In some other cases, the storage device can decrypt the encrypted data to get the original data, and encrypt the original data again using the first AES algorithm 724.

The PQC-FHE algorithm 728 can have a greatest encryption strength (e.g., quantum-safe encryption) among the plurality of cryptographic algorithms. In some implementations, as illustrated in FIG. 7, first data with the non-confidential level 712 can be stored as plain text 722 without encryption, second data with the confidential level 714 can be encrypted using the first AES algorithm 724 (e.g., AES-128 or AES-192), third data with the highly confidential level 716 can be encrypted using the second AES algorithm 726 (e.g., AES-256), and fourth data with the top secret level 718 can be encrypted using the PQC-FHE algorithm 728. In such a way, the fourth data with the top secret level 718 can be protected using the PQC-FHE algorithm 728 against quantum computing attacks.

As noted above, as data encryption using the PQC-FHE algorithm 728 can consume larger computational resources and storage space, a size of the fourth data (with the top secret level 718) can be smaller than a size of the first data, a size of the second data, or a size of the third data. For example, the size of the fourth data can be no more than 1% of the size of the first data, the size of the second data, or the size of the third data. Similarly, the size of the third data can be smaller than the size of the second data that can be smaller than the size of the first data. By allocating data with different security levels for different cryptographic algorithms, a performance of a storage device like the storage device 310 of FIG. 3 can be improved compared to a storage device using a single cryptographic algorithm like the storage device 210 of FIG. 2.

With continued reference to FIG. 3, in some implementations, the controller 312 determines a security level associated with data based on a security label for the data. In some implementations, the controller 312 determines the security label for the data by receiving the security label for the data from the host device 320. The host device 320 can include a security labelling module 322 configured to determine the security label associated with the data. The security labelling module 322 can be implemented by software (e.g., programming instructions) or hardware (e.g., logic units or logic circuits). In some cases, the security labelling module 322 determines the security label associated with the data based on a user input. In some cases, as described below, the security labelling module 322 determines the security label for the data based on one or more characteristics of the data or based on a specific rule.

In some implementations, the controller 312 includes a security labelling module 314 configured to determine the security label associated with the data. The security labelling module 314 can be implemented by software (e.g., programming instructions) or hardware (e.g., logic units or logic circuits). The security labelling module 314 can be configured to determine the security label for the data based on one or more characteristics of the data or based on a specific rule.

The one or more characteristics of the data can include a source of the data (e.g., specific computers or users) or an importance level of the data (e.g., specific data). As an example, government sensitive data, data from financial institutions (such as financial information, account information, transaction information), military data, or any other sensitive data can be labelled as top secret level (a highest security level) or a highly confidential level. In comparison, public data (e.g., newspaper or publication) can be labelled as non-confidential level (a lowest security level). As another example, data from top officials (e.g., CEO, CFO, CTO) of a company can be labelled as top secret level; in comparison, data from managers or directors of the company can be labelled as highly confidential level, and data from workers of the company can be labelled as confidential level, and data about company public information can be labelled as non-confidential level.

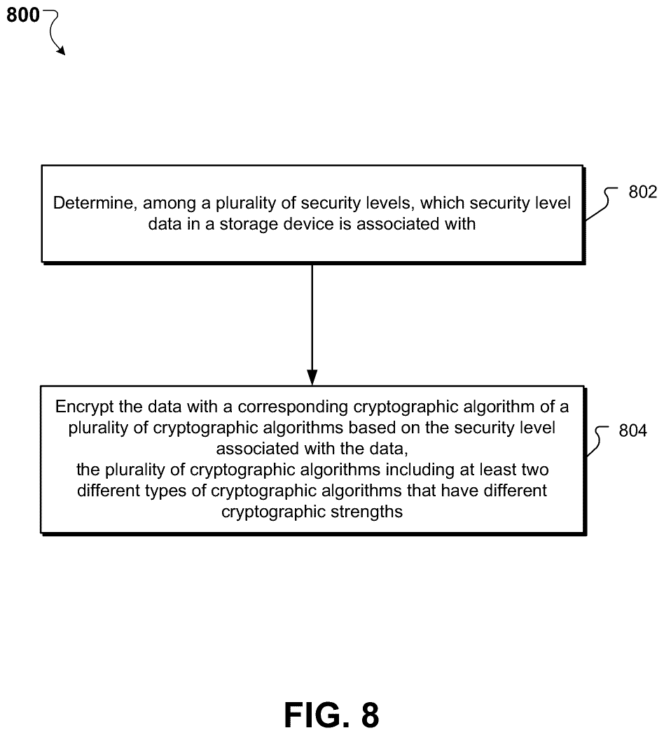

FIG. 8 is a flow chart of an example process 800 for managing data security in a storage device. The storage device can be the device 110 of FIG. 1 or the storage device 310 of FIG. 3. The storage device can include at least one memory device (e.g., the memory device 150 of FIG. 1 or the memory device 350 of FIG. 3) and a controller (e.g., the device controller 112 of FIG. 1 or the controller 312 of FIG. 3). The at least one memory device can include one or more NAND flash memory chips, and the storage device can include a solid-state drive (SSD). The process 800 can be performed by the controller.

At 802, the controller determines, among a plurality of security levels, which security level data is associated with. The plurality of security levels can include, e.g., as illustrated in FIG. 7, non-confidential level, confidential level, highly confidential level, and top secret level.

In some implementation, the controller is configured to: determine which security level the data is associated with based on a security label for the data, the security label for the data corresponding to the security level associated with the data. In some implementations, the controller is configured to determine the security label for the data by receiving the security label for the data from a host device (e.g., the host device 120 of FIG. 1 or 320 of FIG. 3). For example, e.g., as illustrated in FIG. 3, the host device can include a security labelling module (e.g., the security labelling module 322 of FIG. 3) configured to determine the security label associated with the data. In some implementations, the controller is configured to determine the security label for the data based on one or more characteristics of the data or a specific rule. The controller can include a security labelling module (e.g., the security labelling module 314 of FIG. 3) configured to determine the security label for the data. The one or more characteristics of the data can include at least one of a source of the data or an importance level of the data.

At 804, the controller encrypts the data with a corresponding cryptographic algorithm of a plurality of cryptographic algorithms based on the security level associated with the data. The plurality of cryptographic algorithms can include at least two different types of cryptographic algorithms that have different cryptographic strengths. Each of the plurality of security level can be associated with a respective one of the plurality of cryptographic algorithms, a higher security level corresponding to a cryptographic algorithm with a higher cryptographic strength.

In some examples, the controller encrypts first data with a first type of cryptographic algorithm and encrypts second data with a second type of cryptographic algorithm. The first data is associated with a first security level (e.g., highly confidential level 716 of FIG. 7), and the second data is associated with a second security level (e.g., top secret level 718 of FIG. 7) that is higher than the first security level. The second type of cryptographic algorithm (e.g., PQC-FHE algorithm 728 of FIG. 7) can have a greater encryption strength than the first type of cryptographic algorithm (e.g., AES algorithm 726 of FIG. 7).

In some cases, a first ratio between the encrypted first data and the first data is smaller than a second ratio between the encrypted second data and the second data. The second ratio is more than one order of magnitude greater than the first ratio, e.g., 30 to 100 times or more.

In some examples, the first type of cryptographic algorithm includes an Advanced Encryption Standard (AES) algorithm, and the second type of cryptographic algorithm comprises a post-quantum cryptography (PQC) algorithm. The second type of cryptographic algorithm includes a post-quantum cryptography (PQC) algorithm with fully homomorphic encryption (FHE), e.g., a lattice-based PQC algorithm.

In some implementations, the controller is configured to encrypt third data with the first type of cryptographic algorithm, and the third data is associated with a third security level (e.g., confidential level 714 of FIG. 7) that is smaller than the first security level. The controller can be configured to encrypt the first data with a first key and encrypt the third data with a second key, and a size of the second key (e.g., 128 bits) can be smaller than a size of the first key (e.g., 192 bits or 256 bits).

In some implementations, a size of the first data is greater than a size of the second data. The size of the first data can be more than one order of magnitude greater than the size of the second data, e.g., 100 or 1000 more.

In some implementations, the controller is configured to control an operation (e.g., the operation 616 of FIG. 6) for the encrypted second data in the at least one memory device, e.g., as illustrated in FIG. 6. The operation for the encrypted second data can include at least one of: a computation between a first portion of the encrypted second data and a second portion of the encrypted second data, or a computation between the encrypted second data and another data encrypted using the second type of cryptographic algorithm. The controller can execute the operation on the encrypted second data to generate an encrypted result (e.g., the cypher text 618 of FIG. 6). In some implementations, the controller transmits the encrypted result to the host device.

In some implementations, the controller is configured to store at least one of the encrypted first data or the encrypted second data in the at least one memory device. In some implementations, the controller is configured to transmit at least one of the encrypted first data or the encrypted second data to the host device.

In some implementations, the controller includes a first encryption engine (e.g., the encryption engine 342 of FIG. 3) configured to encrypt the first data using the first type of cryptographic algorithm, and a second encryption engine (e.g., the encryption engine 344 of FIG. 3) configured to encrypt the second data using the second type of cryptographic algorithm.

In some implementations, the controller includes an Error Correction Code (ECC) circuitry (e.g., the ECC circuitry 140 of FIG. 1 or 340 of FIG. 3). The ECC circuitry can include at least one of: one or more min-sum (MS) low-density parity-check (LDPC) decoders (e.g., the MS LDPC decoders 332 of FIG. 3) or one or more bit-flipping-based lite LDPC decoders (e.g., the lite LDPC decoders 334 of FIG. 3).

The disclosed and other examples can be implemented as one or more computer program products, for example, one or more modules of computer program instructions encoded on a computer readable medium for execution by, or to control the operation of, data processing apparatus. The computer readable medium can be a machine-readable storage device, a machine-readable storage substrate, a memory device, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A system may encompass all apparatus, devices, and machines for processing data, including by way of example a programmable processor, a computer, or multiple processors or computers. A system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed for execution on one computer or on multiple computers that are located at one site or distributed across multiple sites and interconnected by a communications network.

The processes and logic flows described in this document can be performed by one or more programmable processors executing one or more computer programs to perform the functions described herein. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer can include a processor for performing instructions and one or more memory devices for storing instructions and data. Generally, a computer can also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data can include all forms of nonvolatile memory, media and memory devices, including by way of example semiconductor memory devices, e.g., EPROM, EEPROM, and flash memory devices; magnetic disks. The processor and the memory can be supplemented by, or incorporated in, special purpose logic circuitry.

While this document may describe many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination in some cases can be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

What is claimed is:

1. A storage device comprising:
at least one memory device; and
a controller coupled to the at least one memory device and configured to:
encrypt first data with a first type of cryptographic algorithm, and
encrypt second data with a second type of cryptographic algorithm,
wherein the first data is associated with a first security level, and the second data is associated with a second security level that is higher than the first security level, and wherein the second type of cryptographic algorithm has a greater encryption strength than the first type of cryptographic algorithm.

2. The storage device of claim 1, wherein a first ratio between the encrypted first data and the first data is smaller than a second ratio between the encrypted second data and the second data.

3. The storage device of claim 1, wherein the first type of cryptographic algorithm comprises an Advanced Encryption Standard (AES) algorithm, and
wherein the second type of cryptographic algorithm comprises a post-quantum cryptography (PQC) algorithm.

4. The storage device of claim 3, wherein the second type of cryptographic algorithm comprises a post-quantum cryptography (PQC) algorithm with fully homomorphic encryption (FHE).

5. The storage device of claim 1, wherein the controller is configured to encrypt third data with the first type of cryptographic algorithm, and the third data is associated with a third security level that is smaller than the first security level, and
wherein the controller is configured to encrypt the first data with a first key and encrypt the third data with a second key, and a size of the second key is smaller than a size of the first key.

6. The storage device of claim 1, wherein the controller is configured to store at least one of the encrypted first data or the encrypted second data in the at least one memory device.

7. The storage device of claim 1, wherein a size of the first data is greater than a size of the second data.

8. The storage device of claim 1, wherein the controller is configured to control an operation for the encrypted second data in the at least one memory device.

9. The storage device of claim 8, wherein the operation for the encrypted second data comprises at least one of:
a computation between a first portion of the encrypted second data and a second portion of the encrypted second data, or
a computation between the encrypted second data and another data encrypted using the second type of cryptographic algorithm.

10. The storage device of claim 1, wherein the controller is configured to transmit at least one of the encrypted first data or the encrypted second data to an external device.

11. The storage device of claim 1, wherein the controller comprises:
a first encryption engine configured to encrypt the first data using the first type of cryptographic algorithm, and
a second encryption engine configured to encrypt the second data using the second type of cryptographic algorithm.

12. The storage device of claim 1, wherein the controller is configured to determine which security level data is associated with and encrypt the data based on the determined security level associated with the data.

13. The storage device of claim 12, wherein the controller is configured to:
encrypt the first data using the first type of cryptographic algorithm in response to determining that the first data is associated with the first security level, and
encrypt the second data using the second type of cryptographic algorithm in response to determining that the second data is associated with the second security level.

14. The storage device of claim 12, wherein the controller is configured to:
determine which security level the data is associated with based on a security label for the data, the security label for the data corresponding to the security level associated with the data.

15. The storage device of claim 14, wherein the controller is configured to determine the security label for the data by receiving the security label for the data from a host device.

16. The storage device of claim 13, wherein the controller is configured to determine the security label for the data based on one or more characteristics of the data.

17. The storage device of claim 1, wherein the controller comprises an Error Correction Code (ECC) circuit comprising at least one of:
one or more min-sum (MS) low-density parity-check (LDPC) decoders or
one or more bit-flipping-based lite LDPC decoders.

18. A storage device comprising:
at least one memory device; and
a controller coupled to the at least one memory device and configured to:
determine, among a plurality of security levels, which security level data is associated with; and
encrypt the data with a corresponding cryptographic algorithm of a plurality of cryptographic algorithms based on the security level associated with the data,
wherein the plurality of cryptographic algorithms comprise at least two different types of cryptographic algorithms that have different cryptographic strengths, and
wherein each of the plurality of security level is associated with a respective one of the plurality of cryptographic algorithms, a higher security level corresponding to a cryptographic algorithm with a higher cryptographic strength.

19. The storage device of claim 18, wherein the controller is configured to perform at least one of:
storing the encrypted data in the at least one memory device,
transmitting the encrypted data to a host device,
conducting computation on the encrypted data to generate an encrypted result, or
transmitting the encrypted result to the host device.

20. The storage device of claim 18, wherein the controller is configured to determine which security level the data is associated with based on a security label for the data, the security label for the data corresponding to the security level associated with the data, and
wherein the controller is configured to determine the security label for the data based on at least one of:
receiving the security label for the data from a host device, or
determining the security label for the data based on one or more characteristics of the data.

21. A method of managing data security in a storage device, the method comprising:
determining, among a plurality of security levels, which security level data in the storage device is associated with; and
encrypting the data with a corresponding cryptographic algorithm of a plurality of cryptographic algorithms based on the security level associated with the data,
wherein the plurality of cryptographic algorithms comprises at least two different types of cryptographic algorithms that have different cryptographic strengths, and
wherein each of the plurality of security level is associated with a respective one of the plurality of cryptographic algorithms, a higher security level corresponding to a cryptographic algorithm with a higher cryptographic strength.
